(19) United States
(12) Patent Application Publication
(10) Pub. No.: US 2021/0011601 A1
(43) Pub. Date: Jan. 14, 2021

(54) METHOD, APPARATUS, AND COMPUTER SYSTEM OF USING AN ACTIVE PEN TO WAKE A COMPUTER DEVICE FROM A POWER-SAVING MODE

(71) Applicant: NOVATEK MICROELECTRONICS CORP., Hsinchu Science Park (TW)

(72) Inventors: Jiun-Jie TSAI, Zhubei City (TW); He-Wei HUANG, Hsinchu City (TW)

(21) Appl. No.: 16/510,541

(22) Filed: Jul. 12, 2019

(51) Int. Cl. G06F 3/041; G06F 3/0354; G06F 1/3218

(52) U.S. Cl. CPC G06F 3/04162; G06F 1/3218; G06F 3/03545

(57) ABSTRACT

A method of using an active pen to wake a computer device from a power-saving mode is provided. The computer device includes a detecting apparatus, a processor, and a touch screen display panel. When the computer device is in a power-saving mode, the detecting apparatus continuously detects presence of the active pen within an effective detecting range with respect to the touch screen display panel. The detecting apparatus transmits a wakeup signal to the processor to wake the computer device when the detection circuit detects that the active pen is within the effective detecting range.

### FIELD

The disclosure relates to a computer device that is used with an active pen, and more particularly to a method of using an active pen to wake a computer device from a power-saving mode.

### BACKGROUND

Nowadays, mobile devices such as smartphones and tablet computers commonly employ touch screen display panels as means of input. When a mobile device operates in a power-saving mode where the touch screen display panel is deactivated (display off) and thus is unable to display images, with a manual operation such as tapping on the touch screen display panel, pressing a power button, etc., users are able to wake the mobile device, namely, switch the mobile device into an active mode where the touch screen display panel is activated (display on) to be able to display images and perform touch reporting (sending information such as location, pressure, direction of movement, etc., of a touch event to a processor of the mobile device).

Some mobile devices have active pens that enable users to perform more precise operation on the touch screen display panels than using fingers. However, when a mobile device is in the power-saving mode, the required manual operation such as tapping on the touch screen display panel using a finger or the active pen, to activate the touch screen display panel maybe rather troublesome.

Furthermore, a conventional way of waking a mobile device from the power-saving mode by touch operation involves a touch sensing circuit sending a wakeup signal to the processor upon detecting a touch operation on the touch screen display panel, followed by the processor waking, in response to receipt of the wakeup signal, a display driver circuit that is used to drive the display function of the touch screen display panel, so that the touch screen display panel can receive and display images fed by the processor. Under this operating principle, the activation of the display driver circuit cannot be performed until the processor receives the wakeup signal from the touch sensing circuit, resulting in unwanted delay.

### SUMMARY

Therefore, an object of the disclosure is to provide a method of using an active pen to wake a computer device from a power-saving mode.

According to the disclosure, the method includes: by a touch sensing and active pen detecting apparatus of the computer device and when the computer device is in the power-saving mode where a touch screen display panel of the computer device is deactivated, continuously detecting presence of the active pen within an effective detecting range with respect to the touch screen display panel of the computer device; and by the touch sensing and active pen detecting apparatus when the computer device is in the power-saving mode, transmitting a wakeup signal to a processor of the computer device to switch the computer device to an active mode where the touch screen display panel is activated and displays images, upon detecting that the active pen is within the effective detecting range.

Another object of the disclosure is to provide an apparatus for cooperating with an active pen to wake a computer device from a power-saving mode.

According to the disclosure, the apparatus is proposed to include a detection circuit and a control circuit. The control circuit is electrically coupled to the detection circuit, is to be electrically coupled to a processor of the computer device, and is configured to, when the computer device is in the power-saving mode where a touch screen display panel thereof is deactivated: i) control the detection circuit to continuously detect presence of the active pen within an effective detecting range with respect to the touch screen display panel; and ii) transmit, when the detection circuit detects that the active pen is within the effective detecting range, a wakeup signal to the processor of the computer device to switch the computer device to an active mode where the touch screen display panel is activated and displays images.

Yet another object of the disclosure is to provide a computer system including an active pen and a computer device that includes a processor, a touch screen display panel, and the apparatus of this disclosure. The control circuit of the apparatus and the touch screen display panel are electrically coupled to the processor.

Yet another object of the disclosure is to

### BRIEF DESCRIPTION OF THE DRAWINGS

Other features and advantages of the disclosure will become apparent in the following detailed description of the embodiment (s) with reference to the accompanying drawings, of which:

FIG. 1 is a block diagram illustrating an embodiment of the computer system according to the disclosure;

FIG. 2 is a schematic diagram illustrating how a detecting zone is defined; and

FIG. 3 is a schematic diagram illustrating operation of the computer system.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

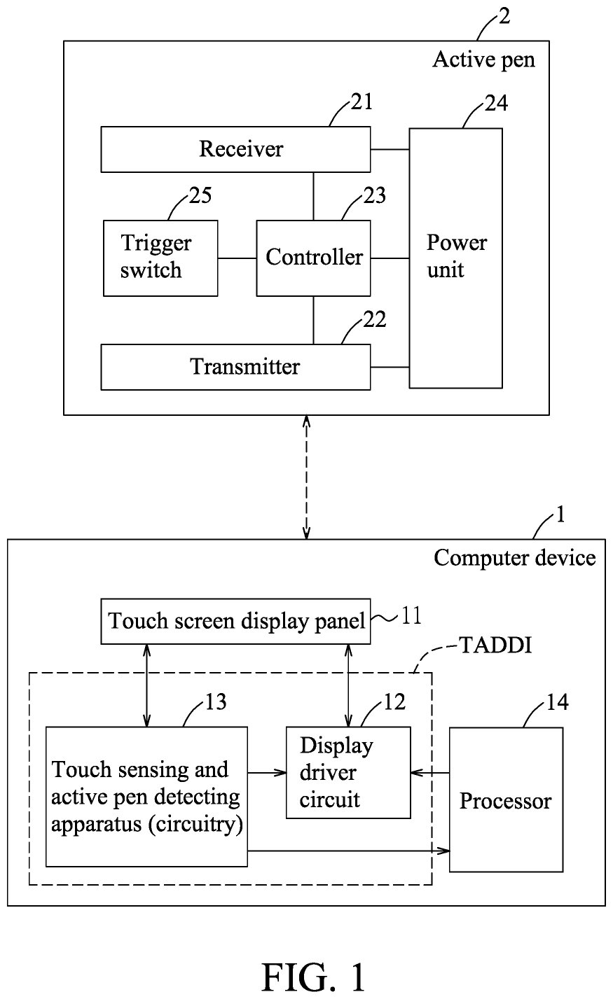

Referring to FIG. 1, the embodiment of the computer system according to this disclosure is shown to include a computer device 1 and an active pen 2. The computer device 1 includes a touch screen display panel 11, a display driver circuit 12 electrically coupled to the touch screen display panel 11, a touch sensing and active pen detecting apparatus 13 electrically coupled to the touch screen display panel 11, and a processor 14 electrically coupled to the display driver circuit 12 and the touch sensing and active pen detecting apparatus 13. In practice, the computer device 1 may be, for example, a smartphone, a tablet computer, and so on, but this disclosure is not limited in this respect.

The active pen 2 is an input device that allows a user to write directly on the touch screen display panel 11, and includes electronic components such as a receiver 21, a transmitter 22, a controller 23 electrically coupled to the receiver 21 and the transmitter 22, and a power unit 24 (e.g., a battery unit) electrically coupled to the receiver 21, the transmitter 22 and the controller 23 for providing electric power thereto.

The computer device 1 is able to operate in an active mode or a power-saving mode. In the active mode, the touch screen display panel 11, the display driver circuit 12 and the touch sensing and active pen detecting apparatus 13 are activated (display on) so as to display images provided by the processor 14 and to perform touch reporting. In the power-saving mode, the touch screen display panel 11 is deactivated (display off, which means that at least the display function is turned off) and thus is unable to display images.

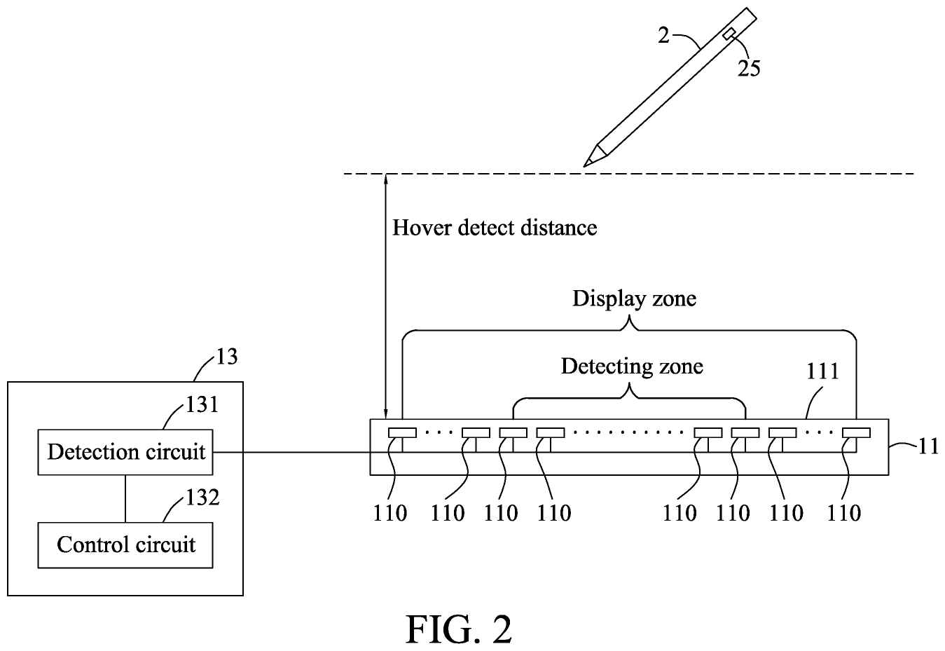

Further referring to FIG. 2, the touch sensing and active pen detecting apparatus 13 is a circuitry that includes a detection circuit 131, and a control circuit 132 electrically coupled to the detection circuit 131. The detection circuit 131 is electrically coupled to a plurality of electrodes 110 of the touch screen display panel 11. The control circuit 132 controls, when the computer device 1 is in the power-saving mode, the detection circuit 131 to continuously transmit, through the electrodes 110, a detecting signal for detecting presence of the active pen 2 within an effective detecting range with respect to the touch screen display panel 11. Generally, the transmitter 22 of the active pen 2 would be mounted at a tip portion of the active pen 2, so the detection circuit 131 essentially detects presence of the tip portion of the active pen 2 within the effective detecting range in such a case, but this disclosure is not limited in this respect, and the transmitter 22 may be mounted to any portion of the active pen 2 by design choice. In one embodiment, for a liquid crystal display (LCD) panel, the electrodes 110 may be common electrodes to which a common voltage (Vcom) is applied, but this disclosure is not limited in this respect. For example, the electrodes 110 may be formed in another layer different from the common electrode layer in other embodiments. The detecting signal may be transmitted in a direction perpendicular to and outward of a panel surface 111 of the touch screen display panel 11.

When the active pen 2 is within the effective detecting range, the controller 23 of the active pen 2 receives the detecting signal via the receiver 21 wirelessly, and transmits a responding signal wirelessly via the transmitter 22 in response to receipt of the detecting signal. Upon receipt of the responding signal via the electrodes 110 and the detection circuit 131, which means that the control circuit 132 has detected that the active pen 2 is within the effective detecting range, the control circuit 132 transmits a first wakeup signal to the processor 14 of the computer device 1 to wake the computer device 1 (i.e., to switch the computer device 1 to the active mode) . In this embodiment, the active pen 2 further includes a trigger switch 25 (e.g., a push button) that is electrically coupled to the controller 23, and that triggers, when being operated (e.g., being pressed), the controller 23 to transmit a trigger signal via the transmitter 22 to wake the computer device 1. When the active pen 2 is outside the effective detecting range, the user may operate the trigger switch 25 to make the computer device 1 enter the active mode from the power-saving mode.

Upon receipt of the first wakeup signal, the processor 14 may proceed to resume the system (i.e., to perform system resumption), and issue a wakeup command to the display driver circuit 12 via a mobile industry processor interface (MIPI) to wake the display driver circuit 12, so that the display driver circuit 12 proceeds with a power-on sequence for the touch screen display panel 11. After completion of the power-on sequence, the touch screen display panel 11 is capable of receiving and displaying images provided by the processor 14.

In another implementation, the control circuit 132 further transmits a second wakeup signal to the display driver circuit 12 to wake the display driver circuit 12 in addition to transmitting the first wakeup signal to the processor 14 upon receipt of the trigger signal, so that the display driver circuit 12 proceeds with the power-on sequence for the touch screen display panel while the processor 14 proceeds with system resumption. Since activation of the display driver circuit 12 can be started without waiting for the processor 14 to receive the first wakeup signal in this case, overall time required for the computer device 1 to enter the active mode from the power-saving mode can be reduced. In this embodiment, the touch sensing and active pen detecting apparatus 13 and the display driver circuit 12 are integrated into a single integrated circuit (IC) package, constituting a touch active-pen display driver IC (TADDI) that facilitates design of the abovementioned simultaneous wakeup procedure (i.e., waking the display driver circuit 12 and performing system resumption of the computer device 1 at the same time) , but this disclosure is not limited in this respect. The touch sensing and active pen detecting apparatus 13 and the display driver circuit may belong to different IC packages in other embodiments.

It is noted that the detection circuit 131 may include a transmitter (not shown) electrically coupled to the electrodes 110 to transmit the detecting signal therethrough, and a receiver (not shown) electrically coupled to the electrodes 110 to receive the responding signal and the trigger signal therethrough, or include a transceiver electrically coupled to the electrodes 110 to transmit the detecting signal and receive the responding signal and the trigger signal therethrough.

It is noted that the effective detecting range herein is a three-dimensional space cooperatively defined by a detecting area on the panel surface 111 and a hover detect distance. The hover detect distance is a maximum vertical distance, measured from the panel surface 111, at which the active pen 2 can still be effectively detected. The hover detect distance may depend on, for example, intensity of the detecting signal, sensitivity of the receiver 21 of the active pen 2, intensity of the responding signal, and so on. Generally, the hover detect distance may be designed as being several centimeters from the panel surface 111 of the touch screen display panel 11. The detecting area may be defined using the electrodes 110. In one implementation, all of the electrodes 110 are used to transmit the detecting signal and receive the responding signal. In one implementation, the control circuit 132 may control the detection circuit 131 to transmit the detecting signal via all of the electrodes 110, and to receive the responding signal and/or the trigger signal via only some of the electrodes 110 that define the detecting area smaller than a display area of the touch screen display panel 11. Accordingly, the active pen 2 will be determined to be within the effective detecting range only when the active pen 2 is above said some of the electrodes 110 that receive the responding signal, and is away from the panel surface 111 by a vertical distance shorter than the hover detect distance. In one example, the detecting area is defined to be a central region of the display area (i.e., excluding edge portions of the display area), as shown in FIG. 2, thereby preventing detection of the active pen 2 from unintentional user action.

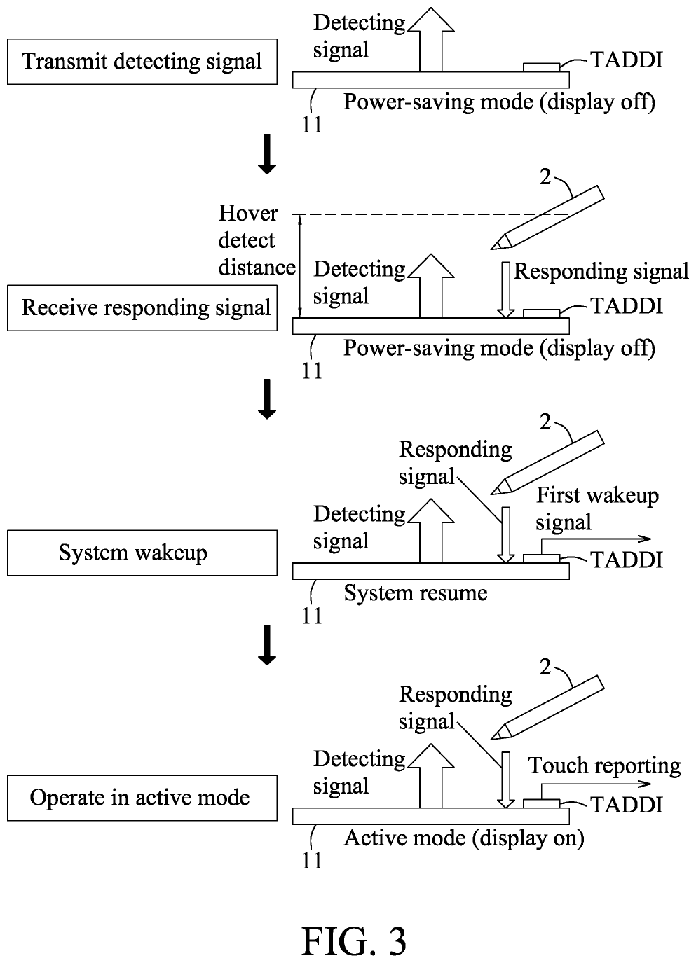

FIG. 3 illustrates operation of the embodiment to wake the computer device 1 from the power-saving mode according to this disclosure. In the power-saving mode, the touch screen display panel 11 is deactivated (display off), and the TADDI transmits the detecting signal via the touch screen display panel 11. When the active pen 2 enters the effective detecting range, the active pen 2 transmits the responding signal in response to receipt of the detecting signal, and the TADDI receives the responding signal. Then, the TADDI transmits the first wakeup signal to the processor 14 (see FIG. 1), so the processor 14 starts system resumption. Once the system resumption is completed, the computer device 1 enters the active mode (display on), and the TADDI starts obtaining coordinates of the active pen 2 with respect to the touch screen display panel 11 (i.e., touch reporting) based on the detecting signal and the responding signal.

In summary, the embodiment of the computer system according to this disclosure can automatically wake the computer device 1 from the power-saving mode when the active pen 2 enters the effective detecting range. In addition, according to one implementation, upon detecting that the active pen 2 is within the effective detecting range, the touch sensing and active pen detecting apparatus 13 may transmit the first and second wakeup signals respectively to the processor 14 and the display driver circuit 12, so as to reduce time required for the computer device 1 to return from the power-saving mode to the active mode.

In the description above, for the purposes of explanation, numerous specific details have been set forth in order to provide a thorough understanding of the embodiment(s). It will be apparent, however, to one skilled in the art, that one or more other embodiments maybe practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

1. A method of using an active pen to wake a computer device from a power-saving mode, the computer device including a touch sensing and active pen detecting apparatus, a processor, and a touch screen display panel, said method comprising:
by the touch sensing and active pen detecting apparatus when the computer device is in the power-saving mode where the touch screen display panel is deactivated, continuously detecting presence of the active pen that is spaced apart from the touch screen display panel but is within an effective detecting range with respect to the touch screen display panel; and
by the touch sensing and active pen detecting apparatus when the computer device is in the power-saving mode, transmitting a first wakeup signal to the processor of the computer device to switch the computer device to an active mode where the touch screen display panel is activated and displays images upon detecting that the active pen is spaced apart from the touch screen display panel but is within the effective detecting range.

2. The method of claim 1, wherein the continuously detecting presence of the active pen includes:
continuously and wirelessly transmitting a detecting signal; and
detecting whether a responding signal that is transmitted by the active pen in response to receipt of the detecting signal by the active pen is received; and
wherein the receipt of the responding signal by the touch sensing and active pen detecting apparatus represents that the active pen is within the effective detecting range.

3. The method of claim 2, the active pen including a trigger switch, the method further comprising:
by the touch sensing and active pen detecting apparatus when the computer device is in the power-saving mode, transmitting the first wakeup signal to the processor of the computer device to switch the computer device to the active mode upon receipt of a trigger signal that is transmitted by the active pen of which the trigger switch is operated by a user when the active pen is outside the effective detecting range.

4. The method of claim 3, the computer device further including a display driver circuit that is configured to drive operation of the touch screen display panel and that is deactivated when the computer device is in the power-saving mode, said method further comprising:
by the touch sensing and active pen detecting apparatus when the computer device is in the power-saving mode, transmitting a second wakeup signal to the display driver circuit to wake the display driver circuit upon receipt of one of the responding signal and the trigger signal.

5. The method of claim 1, the computer device further including a display driver circuit that is configured to drive operation of the touch screen display panel and that is deactivated when the computer device is in the power-saving mode, said method further comprising:
by the touch sensing and active pen detecting apparatus when the computer device is in the power-saving mode, transmitting a second wakeup signal to the display driver circuit of the computer device to wake the display driver circuit upon detecting that the active pen is within the effective detecting range.

6. An apparatus for cooperating with an active pen to wake a computer device from a power-saving mode, the computer device including said apparatus, a processor, and a touch screen display panel, said apparatus comprising:
a detection circuit; and
a control circuit that is electrically coupled to said detection circuit, that is to be electrically coupled to the processor of the computer device, and that is configured to, when the computer device is in the power-saving mode where the touch screen display panel is deactivated:
control said detection circuit to continuously detect presence of the active pen that is spaced apart from the touch screen display panel but is within an effective detecting range with respect to the touch screen display panel; and
transmit, when said detection circuit detects that the active pen is spaced apart from the touch screen display panel but is within the effective detecting range, a first wakeup signal to the processor of the computer device to switch the computer device into an active mode where the touch screen display panel is activated and displays images.

7. The apparatus of claim 6, wherein said control circuit is configured to, when the computer device is in the power-saving mode:
control said detection circuit to continuously and wirelessly transmit a detecting signal; and
transmit the first wakeup signal to the processor of the computer device to switch the computer device to the active mode when said control circuit receives, via said detection circuit, a responding signal that is transmitted by the active pen in response to receipt of the detecting signal by the active pen.

8. The apparatus of claim 7, the active pen including a trigger switch, wherein said control circuit is further configured to, when the computer device is in the power-saving mode:
transmit the first wakeup signal to the processor of the computer device to switch the computer device to the active mode when said control circuit receives, via said detection circuit, a trigger signal that is transmitted by the active pen of which the trigger switch is operated by a user when the active pen is outside the effective detecting range.

9. The apparatus of claim 8, the computer device further including a display driver circuit that is configured to drive operation of the touch screen display panel and that is deactivated when the computer device is in the power-saving mode, wherein said control circuit is to be electrically coupled to the display driver circuit, and is further configured to, when the computer device is in the power-saving mode:
transmit a second wakeup signal to the display driver circuit to wake the display driver circuit when said control circuit receives one of the responding signal and the trigger signal via said detection circuit.

10. The apparatus of claim 6, the computer device further including a display driver circuit that is configured to drive operation of the touch screen display panel and that is deactivated when the computer device is in the power-saving mode, wherein said control circuit is to be electrically coupled to the display driver circuit, and is further configured to, when the computer device is in the power-saving mode:
transmit a second wakeup signal to the display driver circuit of the computer device to wake the display driver circuit when said detection circuit detects that the active pen is within the effective detecting range.

11. The apparatus of claim 10, further comprising said display driver circuit that is integrated with said detection circuit and said control circuit into a single integrated circuit (IC) package.

12. A computer system comprising:
the active pen; and
the computer device that includes the processor, the touch screen display panel, and the apparatus of claim 6;
wherein said control circuit of said apparatus and said touch screen display panel is electrically coupled to said processor.

13. The computer system of claim 12, wherein said control circuit of said apparatus is configured to, when said computer device is in the power-saving mode, control said detection circuit to continuously and wirelessly transmit a detecting signal;
wherein said active pen is configured to transmit a responding signal in response to receipt of the detecting signal when said active pen is within the effective detecting range; and
wherein said control circuit of said apparatus is configured to, when said computer device is in the power-saving mode, transmit the first wakeup signal to said processor to switch said computer device to the active mode when said control circuit receives the responding signal via said detection circuit.

14. The computer system of claim 13, wherein said touch screen display panel includes a plurality of electrodes electrically coupled to said detection circuit for transmitting the detecting signal and for receiving the responding signal; and
wherein said detection circuit is further configured to receive the responding signal via only some of said electrodes that cooperatively define a detecting area smaller than a display area of said touch screen display panel.

15. The computer system of claim 13, wherein said active pen includes a trigger switch, and is configured to transmit a trigger signal when said trigger switch is operated, and said control circuit is further configured to, when said computer device is in the power-saving mode:
transmit the first wakeup signal to said processor to switch said computer device to the active mode when said control circuit receives, via said detection circuit, the trigger signal that is transmitted by said active pen of which said trigger switch is operated by a user when said active pen is outside the effective detecting range.

16. The computer system of claim 15, wherein said computer device further includes a display driver circuit that is electrically coupled to said control circuit and said touch screen display panel, that is configured to drive operation of said touch screen display panel, and that is deactivated when said computer device is in the power-saving mode; and
wherein said control circuit is further configured to, when said computer device is in the power-saving mode:
transmit a second wakeup signal to said display driver circuit to wake said display driver circuit when said control circuit receives one of the responding signal and the trigger signal via said detection circuit.

17. The computer system of claim 12, wherein said computer device further includes a display driver circuit that is electrically coupled to said control circuit and said touch screen display panel, that is configured to drive operation of said touch screen display panel, and that is deactivated when said computer device is in the power-saving mode;
wherein said control circuit is further configured to, when said computer device is in the power-saving mode:
transmit a second wakeup signal to said display driver circuit to wake said display driver circuit when said detection circuit detects that said active pen is within the effective detecting range.

18. The computer system of claim 17, wherein said apparatus further includes said display driver circuit, and said display driver circuit, said detection circuit and said control circuit are integrated into a single integrated circuit (IC) package.
